(19) United States
(12) Patent Application Publication
(10) Pub. No.: US 2010/0085333 A1
(43) Pub. Date: Apr. 8, 2010

(54) INPUT SYSTEM AND METHOD, AND COMPUTER PROGRAM

(76) Inventors: Takayuki Akimoto, Omiya (JP); Manabu Nohara, Tsurugashima (JP); Tomoaki Iwai, Adachi (JP); Yusuke Soga, Nerima (JP); Ryoji Noguchi, Fujimi (JP)

Correspondence Address: NIXON & VANDERHYE, PC, 901 NORTH GLEBE ROAD, 11TH FLOOR, ARLINGTON, VA, 22203, US

(21) Appl. No.: 12/524,090

(22) PCT Filed: Jan. 30, 2007
(86) PCT No.: PCT/JP2007/051443

§ 371 Date: Jul. 22, 2009

(51) Int. Cl. G06F 3/033; G06F 3/038

(52) U.S. Cl. 345/179; 345/213

(57) ABSTRACT

An input system (1) comprise: a display (11) for displaying an image including coordinate information on the display surface; a plurality of indicators (12) having (i) a detecting means for detecting the image displayed on the display surface, and (ii) a transmitting means for transmitting transmission information generated according to the coordinate information contained in the detected image; and a controller (13) having (i) a receiving means for receiving the transmission information, (ii) a generating means for generating drawing information indicating the path along which each of the indicators moves on the display surface according to the transmission information, and (iii) a control means for controlling the display so as to perform the drawing processing corresponding to the drawing information generated by the generating means. The display displays an image by emitting a plurality of pulses and displays the coordinate information by using part of the pulses.

### TECHNICAL FIELD

The present invention relates to an input system and method which can be used as an electronic whiteboard, an electronic blackboard, or the like used at a conference room or the like, and a computer program which can make a computer function as such an input system.

### BACKGROUND ART

In recent years, instead of a whiteboard conventionally used in conference or the like, an input system referred to as an electronic whiteboard or an electronic blackboard has been increasingly introduced. In such an input system, a pen-type indicating apparatus is used to make a tracing on a display surface of a display apparatus, such as a plasma display, and to perform a drawing process according to the traced trajectory (e.g. a process of displaying the trajectory so as to be visually recognized), which allows the pen-type indicator to be used like a magic marker or the like (refer to a patent document 1). By this, a user can use the input system, such as an electronic whiteboard, feeling extremely similar to the conventionally used whiteboard.

Patent document 1: Japanese Patent Application Laid Open No. Hei 7-319615

### DISCLOSURE OF INVENTION

### Subject to be Solved by the Invention

However, for example, in the input system disclosed in the patent document 1, the position detection (e.g. detection of the traced trajectory) of the indicating apparatus (or indicating device) is performed in an electromagnetic induction method using a loop antenna group. Thus, it is necessary to perform the electromagnetic induction throughout the entire display surface of the display apparatus. However, as the display surface increases in size, a range to perform the electromagnetic induction increases, so it is necessary to increase the output of an electromagnetic wave emitted from the loop antenna group. This increases power consumption and manufacturing costs. Moreover, the electromagnetic wave used in the electromagnetic induction method does not have directivity. Thus, if a plurality of display apparatuses (input devices) are aligned, although the indicating apparatus is actually displaced on a certain display apparatus, it is falsely recognized that the indicating apparatus is displaced on the adjacent display apparatus, which is technically problematic. In other words, there is such a technical problem that an indication on the certain display apparatus may have an adverse effect on the adjacent display apparatus. Thus, for example, in the input system disclosed in the patent document 1, it is hardly possible to dispose the plurality of display apparatuses.

In view of the aforementioned problems, it is therefore an object of the present invention to provide, for example, an input system and method which can preferably perform the input associated with the drawing process or the like on the display apparatus by using the plurality of indicating apparatuses, and a computer program which makes a computer function as such an input system.

### Means for Solving the Subject

The above object of the present invention can be achieved by an input system provided with: a display apparatus for displaying an image on a display surface, the image including coordinate information indicating a coordinate position on the display surface; a plurality of indicating apparatuses for giving an indication for a drawing process with respect to the display apparatus by being displaced on the display surface, each of the indicating apparatuses provided with (i) a detecting device for detecting the image displayed on the display surface and (ii) a transmitting device for transmitting transmission information generated on the basis of the coordinate information included in the image detected by the detecting device; and a control apparatus for controlling the drawing process with respect to the display apparatus on the basis of the indication by each of the plurality of indicating apparatuses, the control apparatus provided with (i) a receiving device for receiving the transmission information transmitted by the transmitting device, (ii) a generating device for generating drawing information on the basis of the transmission information, the drawing information indicating a trajectory that each of the plurality of indicating apparatuses is displaced on the display surface, and (iii) a controlling device for controlling the display apparatus to perform the drawing process according to the drawing information generated by the generating device, the display apparatus displaying one image by emitting a plurality of pulses, the display apparatus also displaying the coordinate information on the display surface by using one portion of the plurality of pulses emitted in predetermined timing, the detecting device detecting the image in the predetermined timing in which the coordinate information is displayed on the display surface.

The above object of the present invention can be also achieved by an input method in an input system provided with; a display apparatus for displaying an image on a display surface, the image including coordinate information indicating a coordinate position on the display surface; a plurality of indicating apparatuses for giving an indication for a drawing process with respect to the display apparatus by being displaced on the display surface; and a control apparatus for controlling the drawing process with respect to the display apparatus on the basis of the indication by each of the plurality of indicating apparatuses, the input method provided with: (i) a detecting process of detecting the image displayed on the display surface and (ii) a transmitting process of transmitting transmission information generated on the basis of the coordinate information included in the image detected by the detecting process, which are performed on each of the plurality of indicating apparatuses; and (i) a receiving process of receiving the transmission information transmitted by the transmitting process, (ii) a generating process of generating drawing information on the basis of the transmission information, the drawing information indicating a trajectory that each of the plurality of indicating apparatuses is displaced on the display surface, and (iii) a controlling process of controlling the display apparatus to perform the drawing process according to the drawing information generated by the generating process, which are performed on the control apparatus, the display apparatus displaying one image by emitting a plurality of pulses, the display apparatus also displaying the coordinate information on the display surface by using one portion of the plurality of pulses emitted in predetermined timing, the detecting process detecting the image in the predetermined timing in which the coordinate information is displayed on the display surface.

The above object of the present invention can be also achieved by a computer program for controlling a computer provided for an input system provided with: a display apparatus for displaying an image on a display surface, the image including coordinate information indicating a coordinate position on the display surface; a plurality of indicating apparatuses for giving an indication for a drawing process with respect to the display apparatus by being displaced on the display surface, each of the indicating apparatuses provided with (i) a detecting device for detecting the image displayed on the display surface and (ii) a transmitting device for transmitting transmission information generated on the basis of the coordinate information included in the image detected by the detecting device; and a control apparatus for controlling the drawing process with respect to the display apparatus on the basis of the indication by each of the plurality of indicating apparatuses, the control apparatus provided with (i) a receiving device for receiving the transmission information transmitted by the transmitting device, (ii) a generating device for generating drawing information on the basis of the transmission information, the drawing information indicating a trajectory that each of the plurality of indicating apparatuses is displaced on the display surface, and (iii) a controlling device for controlling the display apparatus to perform the drawing process according to the drawing information generated by the generating device, the display apparatus displaying one image by emitting a plurality of pulses, the display apparatus also displaying the coordinate information on the display surface by using one portion of the plurality of pulses emitted in predetermined timing, the detecting device detecting the image in the predetermined timing in which the coordinate information is displayed on the display surface (in other words, the aforementioned embodiment of the input system of the present invention (including its various aspects)), the computer program making the computer function as at least one portion of the plurality of indicating apparatuses and the control apparatus.

These operation and other advantages of the present invention will become more apparent from the embodiments explained below.

### BRIEF DESCRIPTION OF DRAWINGS

FIG. 1 is a block diagram conceptually showing the basic structure of an input system in a first example.

FIG. 2 is a block diagram conceptually showing the basic structure of a display apparatus in the first example.

FIG. 3 is a block diagram conceptually showing the basic structure of a pen-type indicator in the first example.

FIG. 4 is a block diagram conceptually showing the basic structure of an application apparatus in the first example.

FIG. 5 is a flowchart conceptually showing a flow of the operations of the display apparatus in the first example.

FIG. 6 is a waveform chart conceptually showing 2000 pulses which constitute one frame image.

FIG. 7 is a schematic diagram conceptually showing a display aspect of a coordinate pattern image and image information obtained in a step S101 in FIG. 5.

FIG. 8 is a flowchart conceptually showing a flow of the operations of the pen-type indicator in the first example.

FIG. 9 is a waveform chart showing a principle of an operation of detecting timing in which the coordinate pattern image is displayed on a display device and a block diagram conceptually showing the detailed structure of a coordinate information display synchronization sensor.

FIG. 10 is a flowchart conceptually showing a flow of the operations of the application apparatus in the first example.

FIG. 11 is a schematic diagram conceptually showing a drawing process, an integration process, and an image displayed as a result.

FIG. 12 is a block diagram conceptually showing the basic structure of a pen-type indicator in a second example.

FIG. 13 is a block diagram conceptually showing the basic structure of an application apparatus in the second example.

FIG. 14 is a flowchart conceptually showing a flow of the operations of the pen-type indicator in the second example.

FIG. 15 is a flowchart conceptually showing a flow of the operations of the application apparatus in the second example.

### DESCRIPTION OF REFERENCE CODES

1 input system
11 display apparatus
111 coordinate information memory device
112 image information input device
113 pulse generation device
114 display device
12 pen-type indicator
121 sensing device
122 pen pressure sensor
123 coordinate information display synchronization sensor
1231 noise sensor
1232 noise signal waveform shaping circuit
124 image processing device
125 position detection device
126 coordinate information memory device
127 transmission information integration device
128 wireless transmission device
129 pen unique ID information memory device
13 application apparatus
131 wireless reception device
132 input processing device
133 drawing processing device
134 integration processing device
135 image information output device

### BEST MODE FOR CARRYING OUT THE INVENTION

Hereinafter, as the best mode for carrying out the present invention, an explanation will be given on embodiments of the input system and method, and the computer program of the present invention.

(Embodiment of Input System)

An embodiment of the input system of the present invention is an input system provided with: a display apparatus for displaying an image on a display surface, the image including coordinate information indicating a coordinate position on the display surface; a plurality of indicating apparatuses for giving an indication for a drawing process with respect to the display apparatus by being displaced on the display surface, each of the indicating apparatuses provided with (i) a detecting device for detecting the image displayed on the display surface and (ii) a transmitting device for transmitting transmission information generated on the basis of the coordinate information included in the image detected by the detecting device; and a control apparatus for controlling the drawing process with respect to the display apparatus on the basis of the indication by each of the plurality of indicating apparatuses, the control apparatus provided with (i) a receiving device for receiving the transmission information transmitted by the transmitting device, (ii) a generating device for generating drawing information on the basis of the transmission information, the drawing information indicating a trajectory that each of the plurality of indicating apparatuses is displaced on the display surface, and (iii) a controlling device for controlling the display apparatus to perform the drawing process according to the drawing information generated by the generating device, the display apparatus displaying one image by emitting a plurality of pulses, the display apparatus also displaying the coordinate information on the display surface by using one portion of the plurality of pulses emitted in predetermined timing, the detecting device detecting the image in the predetermined timing in which the coordinate information is displayed on the display surface.

According to the embodiment of the input system of the present invention, the image including the coordinate information is displayed on the display surface of the display apparatus. Here, with regard to the “image including the coordinate information”, the coordinate information is not necessarily always included in the image, and the coordinate information only needs to be included in at least one portion of the image, or at least one portion of a term or period in which one or a plurality of images are displayed.

In the embodiment, in particular, the display apparatus displays one image by emitting the plurality of pulses. At this time, the coordinate information is displayed by using one portion of the plurality of pulses emitted in the predetermined timing, and the image to be originally displayed other than the coordinate information is displayed by using another portion of the pulses emitted in another timing. In other words, in the embodiment, after the term in which one image is displayed is divided into a plurality of fields, the coordinate information is displayed by using one of the plurality of fields corresponding to the predetermined timing, and the image to be originally displayed other than the coordinate information is displayed by using another portion of the fields corresponding to another timing.

The image including the coordinate information is detected (specifically, for example, imaged) by the detecting device provided for each of the plurality of indicating apparatuses. More specifically, the image displayed on the display surface on which each of the plurality of indicating apparatuses is currently located is detected. In particular, the detecting device detects the image in the timing in which the coordinate information is displayed on the display surface. Thus, since the detected image includes the coordinate information, each of the plurality of indicating apparatuses detects the information indicating the coordinate position on the display surface at which each of the indicating apparatuses is currently located. At this time, the coordinate information included in the detected image (i.e. the information indicating the coordinate position on the display surface at which each of the plurality of indicating apparatuses is currently located) is transmitted to the control apparatus as the transmission information which is generated by performing a predetermined arithmetic process (for example, a process of actually specifying the coordinate position or the like described later) on the coordinate information, or which is the coordinate information itself, by the operation of the transmitting device.

On the control apparatus, the transmission information is received by the operation of the receiving device. The received transmission information includes the coordinate position itself on the display surface at which each of the plurality of indicating apparatuses is currently located or the information indicating the coordinate position. Thus, the generating device can specify at which position on the display surface each of the plurality of indicating apparatuses is located, on the basis of the received transmission information. Therefore, the drawing information indicating the trajectory that each of the plurality of indicating apparatuses is displaced on the display surface is generated by the operation of the generating device. Then, the display apparatus is controlled to perform the drawing process according to the generated drawing information, by the operation of the controlling device. Specifically, for example, the display apparatus is controlled to display the trajectory indicated by the drawing information in a visually recognizable state.

Thus, a user can draw a desired letter or character, graphic, and the like on the desired one of the plurality of display apparatuses by using the input system in the embodiment, feeling extremely similar to the conventionally used whiteboard.

In the embodiment, in particular, the image displayed on the display surface includes the coordinate information, and the coordinate position of each of the plurality of indicating apparatuses on the display surface (i.e. each of the trajectories formed by the plurality of indicating apparatuses being displaced on the display surface) is specified on the basis of the image detected by each of the plurality of indicating apparatuses. In other words, by using the normal image display operation principle of the display apparatus, the coordinate position of each of the plurality of indicating apparatuses is specified. Thus, even if the display surface of the display apparatus is large, power consumption and manufacturing costs necessary to specify the coordinate position of each of the plurality of indicating apparatuses rarely increase.

Moreover, even if the plurality of display apparatuses are adjacently disposed, it is possible to specify the coordinate position on the display surface without interference from the adjacent display apparatus. Specifically, for example, as long as one indicating apparatus is displaced on the display surface of one display apparatus, the displacement of the one indicating apparatus does not have an adverse effect on another display apparatus, and moreover, the presence of this another display apparatus does not have an adverse effect on the specification of the coordinate position of the one indicating apparatus. By this, even if the plurality of display apparatuses are arranged, a user can draw the desired letter or character, graphic, and the like on the desired display apparatus of the plurality of display apparatuses, by using the plurality of indicating apparatuses without a particular inconvenience.

Incidentally, if the plurality of display apparatuses are adjacent to each other, the coordinate information included in the image is preferably the coordinate information unique to each of the display apparatuses. By this, it is possible to preferably specify the coordinate position on the display surface of each of the plurality of indicating apparatuses.

In one aspect of the embodiment of the input system of the present invention, the display apparatus displays one image by emitting a plurality of pulses and displays the coordinate information on the display surface by using the one portion of the plurality of pulses emitted in initial timing.

According to this aspect, it is possible to include the coordinate information in the image without having an adverse effect on the image to be originally displayed.

In another aspect of the embodiment of the input system of the present invention, each of the plurality of indicating apparatuses is further provided with a synchronizing device for detecting the predetermined timing in which the coordinate information is displayed on the display surface, and the detecting device detects the image in the predetermined timing detected by the synchronizing device.

According to this aspect, the detecting device can preferably detect the image including the coordinate information, on the basis of the timing detected by the synchronizing device.

In an aspect of the input system provided with the synchronizing device, as described above, the display apparatus may display one image by emitting a plurality of pulses and displays the coordinate information on the display surface by using one portion of the plurality of pulses emitted in initial timing, and the synchronizing device may detect the timing in which the coordinate information is displayed on the display surface by detecting a noise pulse emitted from the display surface (e.g. a noise pulse according to a reset pulse described later) between completion of the display of the one image and beginning of the display of an image to be displayed next to the one image.

By virtue of such construction, it is possible to include the coordinate information in the image without having an adverse effect on the image to be originally displayed, and it is also possible to detect the timing in which the coordinate information is displayed, preferably and relatively easily.

In another aspect of the embodiment of the input system of the present invention, one of the plurality of indicating apparatuses is further provided with a specifying device for specifying the coordinate position at which the one indicating apparatus is located on the display surface, on the basis of the coordinate information included in the image detected by the detecting device, and the transmitting device transmits the coordinate position specified by the specifying device as the transmission information.

According to this aspect, each of the plurality of indicating apparatuses can specify at which position on the display surface each of the indicating apparatuses is located. Therefore, on the control apparatus, it is possible to perform the aforementioned various operations (specifically, the generation of the drawing information and the like), relatively easily, on the basis of a result of the specification on each of the plurality of indicating apparatuses.

In another aspect of the embodiment of the input system of the present invention, the generating device is further provided with a specifying device for specifying the coordinate position at which each of the plurality of indicating apparatuses is located on the display surface, on the basis of the transmission information transmitted by the transmitting device.

According to this aspect, it is possible to specify at which position on the display surface each of the plurality of indicating apparatuses is located, on the control apparatus side. Therefore, as compared to the construction that each of the plurality of indicating apparatuses specifies at which position on the display surface each of the plurality of indicating apparatuses is located, it is possible to simplify the structure of the control apparatus. This leads to a reduction in the power consumption and the manufacturing costs of the input system. In particular, as the input system is provided with more indicating apparatuses, there is a higher effect on the reduction in the power consumption and the manufacturing costs of the input system.

In another aspect of the embodiment of the input system of the present invention, the generating device generates the drawing information indicating the trajectory that each of the plurality of indicating apparatuses is displaced on the display surface, as a plurality of layer information distinguished in accordance with time, and the controlling device controls the display apparatus to perform the drawing process according to any one of, or an integrated result of at least two or all of the plurality of layer information.

According to this aspect, it is possible to perform the selective drawing process according to the displacement of each of the plurality of indicating apparatuses in a particular time zone.

In another aspect of the embodiment of the input system of the present invention, the generating device generates the drawing information indicating the trajectory that each of the plurality of indicating apparatuses is displaced on the display surface, for each of the plurality of indicating apparatuses.

According to this aspect, by specifying which of the plurality of indicating apparatus is located at which position on the display surface, it is possible to generate the drawing information for each of the plurality of indicating apparatuses.

In an aspect of the input system in which the drawing information is generated for each of the plurality of indicating apparatuses, as described above, unique identification information for an indicating apparatus may be assigned to each of the plurality of indicating apparatuses, and the transmitting device may transmit the transmission information including each of the coordinate information and the identification information for an indicating apparatus.

By virtue of such construction, it is possible to specify which of the plurality of indicating apparatuses is located at which position on the display surface, relatively easily, with reference to the identification information for an indicating apparatus,

In an aspect of the input system in which the drawing information is generated for each of the plurality of indicating apparatuses, as described above, the generating device may generate the drawing information indicating the trajectory that each of the plurality of indicating apparatus is displaced on the display surface, as a plurality of layer information distinguished in accordance with each of the plurality of indicating apparatuses, and the controlling device may control the display apparatus to perform the drawing process according to any one of, or an integrated result of at least two or all of the plurality of layer information.

By virtue of such construction, it is possible to perform the selective drawing process according to the displacement of the desired one of the plurality of indicating apparatuses.

(Embodiment of Input Method)

An embodiment of the input method of the present invention is an input method in an input system provided with: a display apparatus for displaying an image on a display surface, the image including coordinate information indicating a coordinate position on the display surface; a plurality of indicating apparatuses for giving an indication for a drawing process with respect to the display apparatus by being displaced on the display surface; and a control apparatus for controlling the drawing process with respect to the display apparatus on the basis of the indication by each of the plurality of indicating apparatuses (in other words, the aforementioned embodiment of the input system of the present invention (including its various aspects)), the input method provided with: (i) a detecting process of detecting the image displayed on the display surface and (ii) a transmitting process of transmitting transmission information generated on the basis of the coordinate information included in the image detected by the detecting process, which are performed on each of the plurality of indicating apparatuses; and (i) a receiving process of receiving the transmission information transmitted by the transmitting process, (ii) a generating process of generating drawing information on the basis of the transmission information, the drawing information indicating a trajectory that each of the plurality of indicating apparatuses is displaced on the display surface, and (iii) a controlling process of controlling the display apparatus to perform the drawing process according to the drawing information generated by the generating process, which are performed on the control apparatus, the display apparatus displaying one image by emitting a plurality of pulses, the display apparatus also displaying the coordinate information on the display surface by using one portion of the plurality of pulses emitted in predetermined timing, the detecting process detecting the image in the predetermined timing in which the coordinate information is displayed on the display surface.

According to the embodiment of the input method of the present invention, it is possible to receive the same various benefits as those of the embodiment of the input system of the present invention described above.

Incidentally, in response to the various aspects in the embodiment of the input system of the present invention described above, the embodiment of the input method of the present invention can also adopt various aspects.

(Embodiment of Computer Program)

An embodiment of the computer program of the present invention is a computer program for controlling a computer provided for an input system provided with: a display apparatus for displaying an image on a display surface, the image including coordinate information indicating a coordinate position on the display surface; a plurality of indicating apparatuses for giving an indication for a drawing process with respect to the display apparatus by being displaced on the display surface, each of the indicating apparatuses provided with (i) a detecting device for detecting the image displayed on the display surface and (ii) a transmitting device for transmitting transmission information generated on the basis of the coordinate information included in the image detected by the detecting device; and a control apparatus for controlling the drawing process with respect to the display apparatus on the basis of the indication by each of the plurality of indicating apparatuses, the control apparatus provided with (i) a receiving device for receiving the transmission information transmitted by the transmitting device, (ii) a generating device for generating drawing information on the basis of the transmission information, the drawing information indicating a trajectory that each of the plurality of indicating apparatuses is displaced on the display surface, and (iii) a controlling device for controlling the display apparatus to perform the drawing process according to the drawing information generated by the generating device, the display apparatus displaying one image by emitting a plurality of pulses, the display apparatus also displaying the coordinate information on the display surface by using one portion of the plurality of pulses emitted in predetermined timing, the detecting device detecting the image in the predetermined timing in which the coordinate information is displayed on the display surface (in other words, the aforementioned embodiment of the input system of the present invention (including its various aspects)), the computer program making the computer function as at least one portion of the plurality of indicating apparatuses and the control apparatus.

According to the embodiment of the computer program of the present invention, the aforementioned embodiment of the input system of the present invention can be embodied relatively readily, by loading the computer program from a recording medium for storing the computer program, such as a ROM, a CD-ROM, a DVD-ROM, a hard disk or the like, into the computer, or by downloading the computer program, which may be a carrier wave, into the computer via a communication device.

Incidentally, in response to the various aspects of in the embodiment of the input system of the present invention described above, the embodiment of the computer program of the present invention can adopt various aspects.

(Embodiment of Computer Program Product)

An embodiment of the computer program of the present invention is a computer program product in a computer-readable medium for tangibly embodying a program of instructions which is executed by an input system provided with: a display apparatus for displaying an image on a display surface, the image including coordinate information indicating a coordinate position on the display surface; a plurality of indicating apparatuses for giving an indication for a drawing process with respect to the display apparatus by being displaced on the display surface, each of the indicating apparatuses provided with (i) a detecting device for detecting the image displayed on the display surface and (ii) a transmitting device for transmitting transmission information generated on the basis of the coordinate information included in the image detected by the detecting device; and a control apparatus for controlling the drawing process with respect to the display apparatus on the basis of the indication by each of the plurality of indicating apparatuses, the control apparatus provided with (i) a receiving device for receiving the transmission information transmitted by the transmitting device, (ii) a generating device for generating drawing information on the basis of the transmission information, the drawing information indicating a trajectory that each of the plurality of indicating apparatuses is displaced on the display surface, and (iii) a controlling device for controlling the display apparatus to perform the drawing process according to the drawing information generated by the generating device, the display apparatus displaying one image by emitting a plurality of pulses, the display apparatus also displaying the coordinate information on the display surface by using one portion of the plurality of pulses emitted in predetermined timing, the detecting device detecting the image in the predetermined timing in which the coordinate information is displayed on the display surface (in other words, the aforementioned embodiment of the input system of the present invention (including its various aspects)), the computer program product making the computer function as at least one portion of the plurality of indicating apparatuses and the control apparatus.

According to the embodiment of the computer program product of the present invention, the aforementioned embodiment of the input system of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the input system of the present invention.

Incidentally, in response to the various aspects in the aforementioned embodiment of the input system of the present invention, the embodiment of the computer program product of the present invention can also employ various aspects.

These operation and other advantages of the present invention will become more apparent from the examples explained below.

As explained above, according to the embodiment of the input system of the present invention, it is provided with the display apparatus; the plurality of indicating apparatus provided with the detecting device and the transmitting device; and the control apparatus provided with the receiving device, the generating device, and the controlling device, the display apparatus displaying one image by emitting a plurality of pulses, the display apparatus also displaying the coordinate information on the display surface by using one portion of the plurality of pulses emitted in predetermined timing, the detecting device detecting the image in the predetermined timing in which the coordinate information is displayed on the display surface. According to the embodiment of the input method of the present invention, it is provided with the detecting process, the transmitting process, the receiving process, the generating process, and the controlling process, the display apparatus also displaying the coordinate information on the display surface by using one portion of the plurality of pulses emitted in predetermined timing, the detecting process detecting the image in the predetermined timing in which the coordinate information is displayed on the display surface. Therefore, it is possible to preferably perform the input associated with the drawing process or the like with respect to the display apparatus, by using the plurality of indicating apparatuses.

### EXAMPLES

Hereinafter, examples of the present invention will be described with reference to the drawings.

### (1) First Example

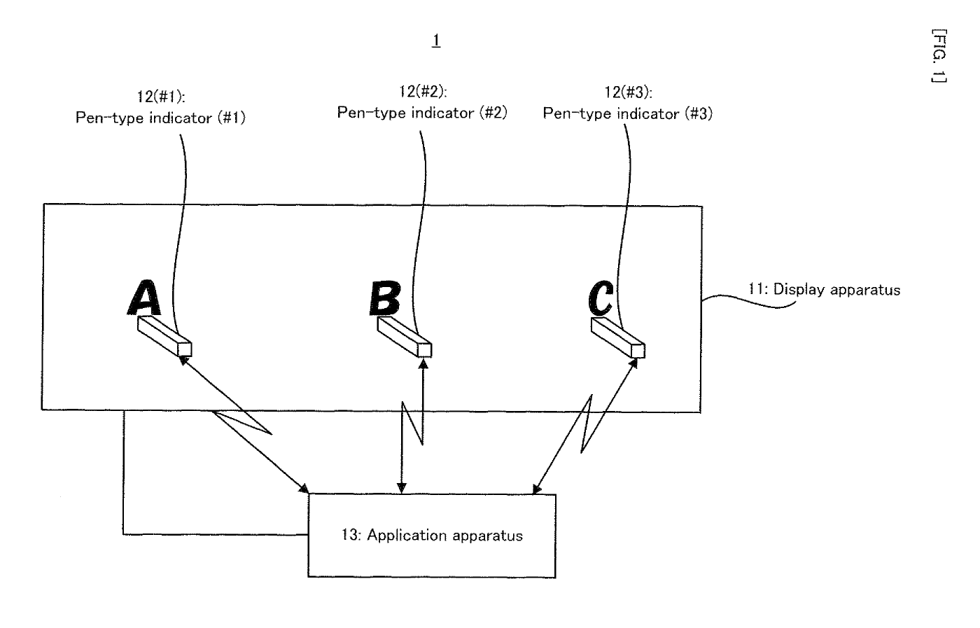

Firstly, with reference to FIG. 1 to FIG. 12, a first example of the input system of the present invention will be explained.

(1-1) Basic Structure

Firstly, with reference to FIG. 1, the basic structure of an input system 1 in the first example will be described. FIG. 1 is a block diagram conceptually showing the basic structure of the input system 1 in the first example.

As shown in FIG. 1, the input system 1 in the first example is provided with a display apparatus 11, a plurality of pen-type indicators 12 (specifically, a pen-type indicator (#1) 12 (#1), a pen-type indicator (#2) 12 (#2), and a pen-type indicator (#3) 12 (#3)), and an application apparatus 13.

The display apparatus 11 constitutes one specific example of the “display apparatus” of the present invention, and it displays a desired image or the like. The display apparatus 11 changes the time and the number of light-emitting pulses, thereby displaying the image or the like. More specifically, for example, the display apparatus 11 emits 2000 pulses while changing their light-emitting time lengths, thereby displaying one image (i.e. one frame image).

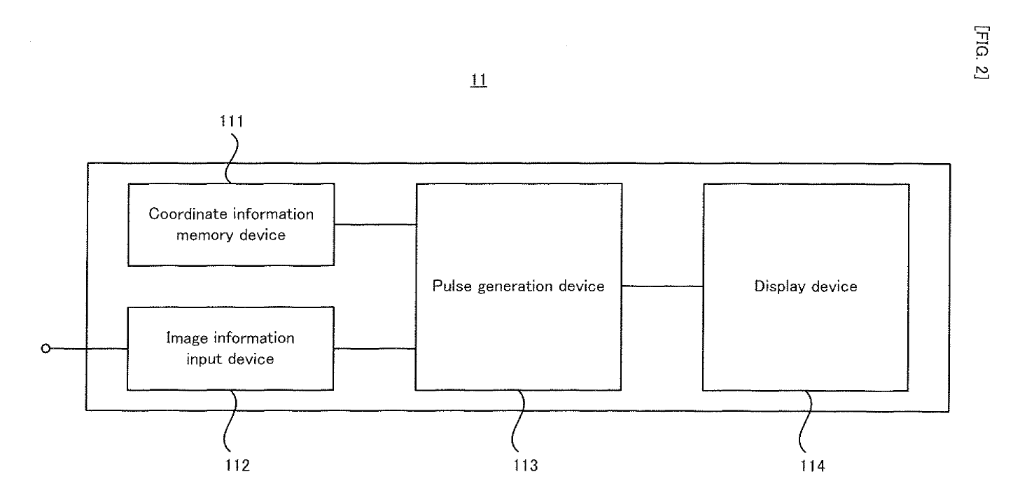

Moreover, the display apparatus 11 also performs a display process (in other words, a drawing process) according to the displacement of the pen-type indicators 12 on a display device 114 (refer to FIG. 2) of the display apparatus 11. For example, the example shown in FIG. 1 shows such a display aspect that the pen-type indicator (#1) 12 (#1) is displaced to draw a letter of “A” on the display device 114 of the display apparatus 11, such a display aspect that the pen-type indicator (#2) 12 (#2) is displaced to draw a letter of “B” on the display device 114 of the display apparatus 11, and such a display aspect that the pen-type indicator (#3) 12 (#3) is displaced to draw a letter of “W” on the display device 114 of the display apparatus 11. Incidentally, the display process in the display apparatus 11 is performed under the control of the application apparatus 13. The display process will be detailed later.

The pen-type indicator 12 constitutes one specific example of the “indicating apparatus” of the present invention, and it is operated by a user to be displaced on the display device 114 of the display apparatus 11.

The application apparatus 13 constitutes one specific example of the “control apparatus” of the present invention. The application apparatus 13 controls the display process of displaying the image on the display apparatus 11 and controls the display process according to the displacement of the pen-type indicator 12 on the display device 114 (refer to FIG. 2) of the display apparatus 11.

Next, with reference to FIG. 2, an explanation will be given on the basic structure of the display apparatus 11 provided for the input system 1 in the first example. FIG. 2 is a block diagram conceptually showing the basic structure of the display apparatus 11 in the first example.

As shown in FIG. 2, the display apparatus 11 is provided with a coordinate information memory device 111, an image information input device 112, a pulse generation device 113, and a display device 114.

The coordinate information memory device 111 stores information indicating a coordinate position on the display device 114 (hereinafter referred to as “coordinate information”, as occasion demands). The coordinate information may indicate a coordinate position in every pixel, or a coordinate position in every block of several-pixels, dozen-pixels, or several-tens-pixels. Moreover, as the coordinate information, for example, a pattern image such as a two-dimensional pattern (or a two-dimensional barcode) is listed as one example.

The image information input device 112 receives the input of image information indicating the image to be displayed on the display device 114, outputted from the application apparatus 13.

The pulse generation device 113 generates 2000 pulses for displaying the image indicated by the image information, in accordance with the image information inputted to the image information input device 112. Moreover, the pulse generation device 113 generates first one or several of the 2000 pulses for displaying one frame image, in accordance with the coordinate information stored in the coordinate information memory device 111. In other words, in the first example, the pattern image indicating the coordinate information (hereinafter referred to as a “coordinate pattern image”, as occasion demands) is displayed by emitting the first one or several of the 2000 pulses for displaying one frame image, and the image according to the image information inputted to the image information input device 112 is displayed on the display device 114 by emitting the other pulses.

The display device 114 actually displays the image or the coordinate pattern image by driving light emitting elements or the like which constitute the pixels on the display device 114, in accordance with the pulses generated on the pulse generation device 113.

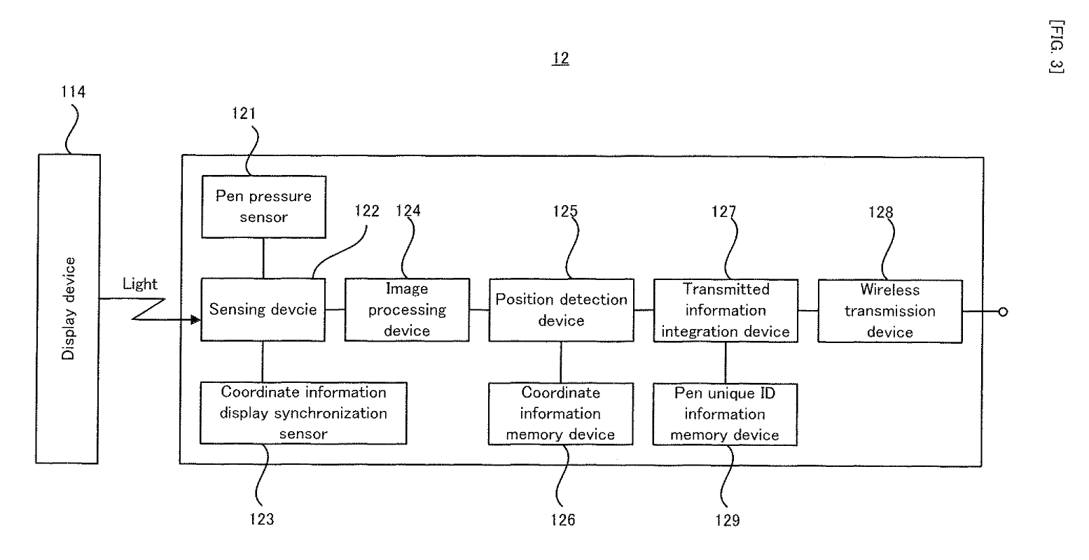

Next, with reference to FIG. 3, an explanation will be given on the basic structure of the pen-type indicator 12 provided for the input system 1 in the first example. FIG. 3 is a block diagram conceptually showing the basic structure of the pen-type indicator 12 in the first example. Incidentally, since the pen-type indicator (#1) 12 (#1), the pen-type indicator (#2) 12 (#2), and the pen-type indicator (#3) 12 (#3) described above have the same structure, hereinafter, they will be collectively explained as the pen-type indicator 12.

As shown in FIG. 3, the pen-type indicator 12 is provided with a sensing device 121, a pen pressure sensor 122, a coordinate information display synchronization sensor 123, an image processing device 124, a position detection device 125, a coordinate information memory device 126, a transmission information integration device 127, a wireless transmission device 128, and a pen unique ID information memory device 129.

The sensing device 121 is disposed near the tip of the pen-type indicator 12 and detects the image displayed on the display device 114. In particular, the sensing device 121 detects the coordinate pattern image out of the image displayed on the display device 114. The detected coordinate pattern image is outputted to the image processing device 124.

The pen pressure sensor 122 detects whether or not the distance between the pen-type indicator 12 and the display device 114 is a distance which allows the sensing device 122 to detect the image. More specifically, the pen pressure sensor 122 is a pressure sensor disposed on the tip of a predetermined structure extending from the vicinity of the tip of the pen-type indicator 12. The predetermined structure has substantially the same length as the distance between the pen-type indicator 12 and the display device 114 which allows the sensing device 121 to detect the image. If the pen pressure sensor 122 does not detect a pressure, since the predetermined structure is not in contact with the display device 114, it is possible to estimate that the distance between the pen-type indicator 12 and the display device 114 is longer than the distance which allows the sensing device 121 to detect the image. In this case, a pen pressure signal outputted from the pen pressure sensor 122 to the sensing device 121 is a signal indicating that the pressure is not detected, and the sensing device 121 does not detect the coordinate pattern image. On the other hand, if the pen pressure sensor 122 detects the pressure, since the predetermined structure is in contact with the display device 114, it is possible to estimate that the distance between the pen-type indicator 12 and the display device 114 is the distance which allows the sensing device 121 to detect the image. In this case, the pen pressure signal outputted from the pen pressure sensor 122 to the sensing device 121 is a signal indicating that the pressure is detected, and the sensing device 121 detects the coordinate pattern image.

The coordinate information display synchronization sensor 123 detects timing in which the coordinate pattern image is displayed on the display device 114. Moreover, the coordinate information display synchronization sensor 123 outputs a synchronization signal indicating the timing to the sensing device 121. The sensing device 121 detects the coordinate pattern image when the timing in which the coordinate pattern image is displayed on the display device 114 is detected by the coordinate information display synchronization sensor 123. On the other hand, the sensing device 121 does not detect the coordinate pattern image when the timing in which the coordinate pattern image is displayed on the display device 114 is not detected by the coordinate information display synchronization sensor 123.

The image processing device 124 converts the coordinate pattern image detected on the sensing device 121 into a format easily processed at a subsequent stage of the image processing device 124. Specifically, the image processing device 124 converts the coordinate pattern image detected on the sensing device 121 into, for example, digital data expressed by “0” and “1”. The coordinate pattern image converted into the digital data is outputted to the position detection device 125.

The position detection device 125 detects the coordinate position indicated by the coordinate pattern image, on the basis of the coordinate pattern image outputted from the image processing device 124. On the pen-type indicator 12, the same coordinate information as the coordinate information stored on the aforementioned coordinate information memory device 111 is stored on the coordinate information memory device 126. Thus, the position detection device 125 compares the coordinate information stored on the coordinate information memory device 126 and the coordinate pattern image outputted from the image processing device 124, thereby detecting the coordinate position indicated by the coordinate pattern image.

The pen unique ID information memory device 129 stores identification information unique to each pen-type indicator 12 (hereinafter referred to as “pen unique ID information”, as occasion demands).

The transmission information integration device 127 generates transmission information (one specific example of the “transmission information” of the present invention) to transmit from the pen-type indicator to the application apparatus 13. Specifically, the transmission information is generated by integrating the information indicating the coordinate position specified on the position detection device 125 and the pen unique ID information about each pen-type apparatus 12 stored on the pen unique information memory device 129.

The wireless transmission device 128 transmits the transmission information generated on the transmission information integration device 127, to the application apparatus 13 by using a wireless communicating device, such as infrared rays.

Incidentally, the sensing device 121 and the image processing device 124 constitute one specific example of the “detecting device” of the present invention. The coordinate information display synchronization sensor 123 constitutes one specific example of the “synchronizing device” of the present invention. The position detection device 125 constitutes one specific example of the “specifying device” of the present invention. The transmission information integration device 127 and the wireless transmission device 128 constitute one specific example of the “transmitting device” of the present invention.

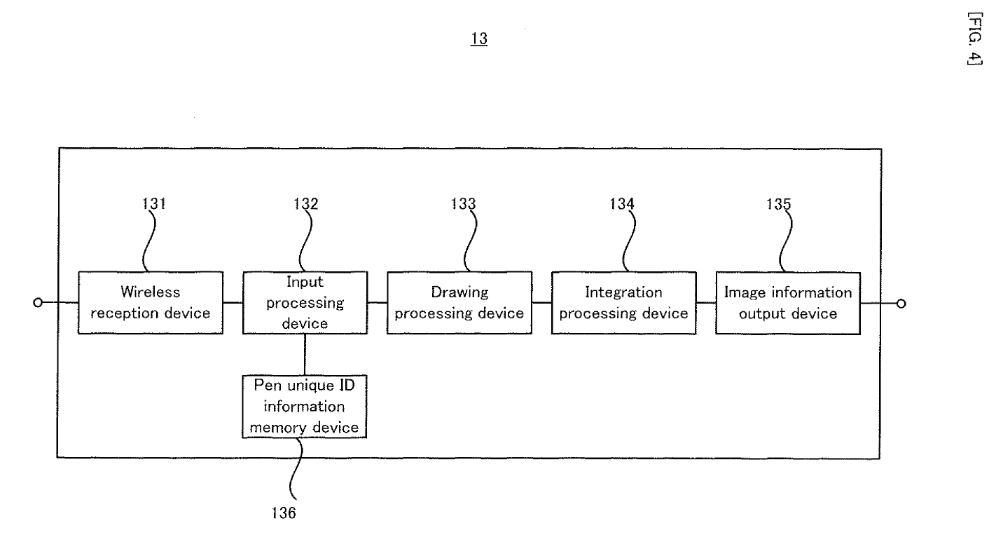

Next, with reference to FIG. 4, an explanation will be given on the basic structure of the application apparatus 13 provided for the input system 1 in the first example. FIG. 4 is a block diagram conceptually showing the basic structure of the application apparatus 13 in the first example.

As shown in FIG. 4, the application apparatus 13 is provided with a wireless reception device 131, an input processing device 132, a drawing processing device 133, an integration processing device 134, an image information output device 135, and a pen unique ID information memory device 136.

The wireless reception device 131 receives the transmission information transmitted from the wireless transmission device 128.

The input processing device 132 separates the transmission information received on the wireless reception device 131 for each pen-type indicator 12a and outputs it to the drawing processing device 133.

Here, on the application apparatus 13, the same pen unique ID information as that stored by the aforementioned pen unique ID information memory device 129 is stored on the pen unique ID information memory device 136. In particular, the same pen unique ID information as all pieces of pen unique ID information about the plurality of pen-type indicators 12 is preferably stored on the pen unique ID information memory device 136. Thus, the input processing device 132 can separate the transmission information for each pen-type indicator by comparing the pen unique ID information stored on the pen unique ID information memory device 136 and the pen unique ID information included in the received transmission information.

The drawing processing device 133 generates drawing information for performing the drawing process at the coordinate position with respect to the display apparatus 11, on the basis of the coordinate position included in the transmission information. More specifically, the drawing processing device 133 generates the drawing information for performing the drawing process which traces the trajectory of the coordinate position (i.e. the trajectory of the displacement of the pen-type indicator 12) which changes with time. The generated drawing information is outputted to the integration processing device 134.

Here, the drawing information may be generated as layer information about each pen-type indicator 12. For example, the drawing information may be generated as the layer information indicating the trajectory of the pen-type indicator (#1) 12 (#1), the layer information indicating the trajectory of the pen-type indicator (#2) 12 (#2), and the layer information indicating the trajectory of the pen-type indicator (#3) 12 (#3).

Alternatively, the drawing information may be generated as layer information for each unit time. For example, the drawing information indicating the trajectory of the coordinate position between a time point T1 and a time point T2 may be generated as the layer information indicating the trajectory of the coordinate position between the time point T1 and a time point t1 (T1<t1<T2), the layer information indicating the trajectory of the coordinate position between the time point t1 and a time point t2 (T1<t1<t2<T2), and the layer information indicating the trajectory of the coordinate position between the time point t2 and the time point T2.

The integration processing device 134 integrates the drawing information (or layer information) generated for each pen type indicator 12, as one drawing information. The integrated drawing information is outputted to the image information output device 135. Incidentally, the integration process will be detailed later.

The image information output device 135 converts the drawing information integrated on the integration processing device 134 to the image information for displaying the image on the display apparatus 11 and outputs it to the display apparatus 11. Moreover, the image information output device 135 may perform the aforementioned conversion process and output process after integrating the image information for displaying the desired image with the drawing information for performing the drawing process at the coordinate position.

As a result, on the display device 114 of the display apparatus 11, the desired image is displayed, and the drawing is performed in accordance with the trajectory of the displacement of the pen-type indicator 12 as shown in FIG. 1.

Incidentally, the wireless reception device 131 constitutes one specific example of the “receiving device” of the present invention. The input processing device 132 and the drawing device 133 constitute one specific example of the “generating device” of the present invention. The integration processing device 134 and the image information output device 135 constitute one specific example of the “controlling device” of the present invention.

(1-2) Operation Principle

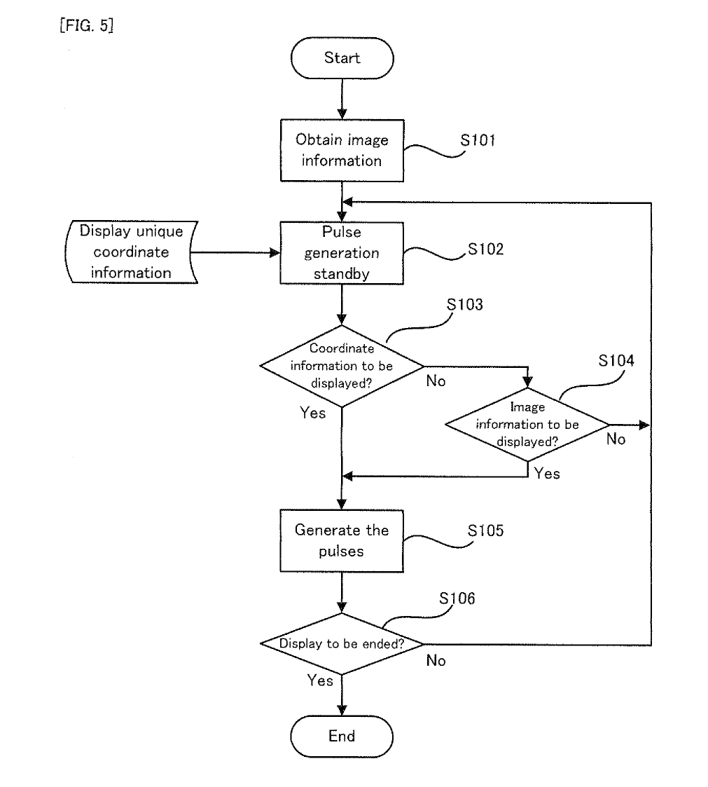

Next, with reference to FIG. 5 to FIG. 11, an explanation will be given on the operation principle of the input system 1 in the first example.

Firstly, with reference to FIG. 5, the operation principle of the display apparatus 1 will be described. FIG. 5 is a flowchart conceptually showing a flow of the operations of the display apparatus 11 in the first example.

As shown in FIG. 5, firstly, the image information outputted from the image information output device 135 is obtained by the operation of the image information input device 112 (step S101).

Then, the pulse generation operation by the pulse generation device 113 goes into standby mode. At this time, the pulse generation device 113 preferably obtains the coordinate information from the coordinate information memory device 111.

Then, it is judged whether or not now is the timing to display the pattern image indicating the coordinate information (i.e. the coordinate pattern image) (step S103).

As a result of the judgment in the step S103, if it is judged that now is the timing to display the pattern image indicating the coordinate information (i.e. the coordinate pattern image) (the step S103: Yes), one or several of the 2000 pulses for displaying one frame image are generated in accordance with the coordinate information stored in the coordinate information memory device 111. In other words, the pulses for displaying the pattern image are generated (step S105). As a result, the light emitting elements or the like which constitute the pixels on the display device 114 are driven in accordance with the generated pulses, and the coordinate pattern image is actually displayed.

On the other hand, as a result of the judgment in the step S103, if it is judged that now is not the timing to display the pattern image indicating the coordinate information (i.e. the coordinate pattern image) (the step S103: No), then, it is judged whether or not now is the timing to display a normal image (i.e. desired image) which is not the pattern image (step S104).

As a result of the judgment in the step S104, if it is judged that now is the timing to display the normal image which is not the pattern image (the step S104: Yes), pulses other than the first one or several of the 2000 pulses for displaying one frame image are generated in accordance with the image information obtained in the step S101. In other words, the pulses for displaying the image indicated by the image information obtained in the step S101 are generated (step S105). As a result, the light emitting elements or the like which constitute the pixels on the display device 114 are driven in accordance with the generated pulses, and the image indicated by the image information obtained in the step S101 is actually displayed.

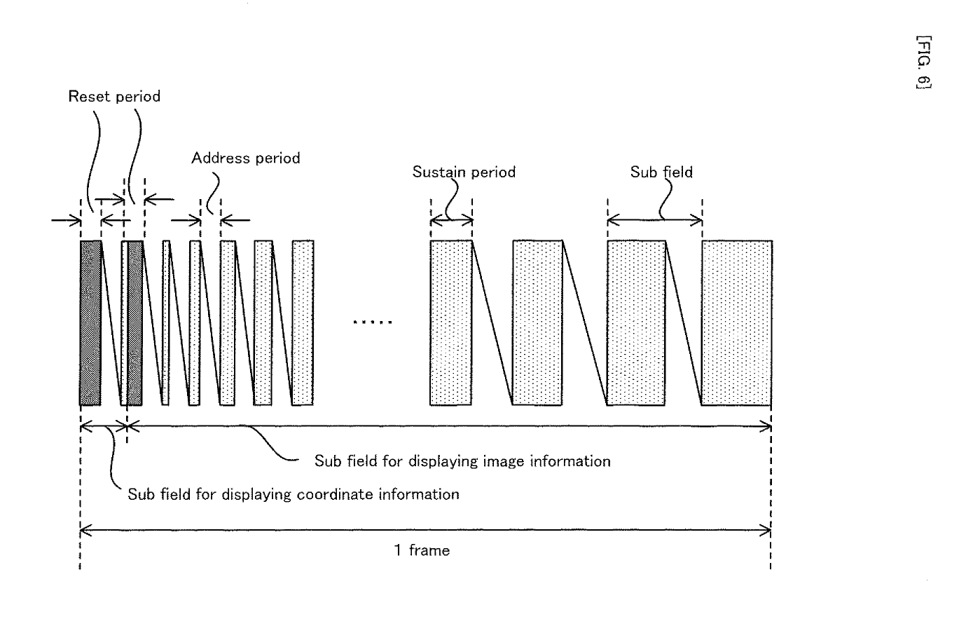

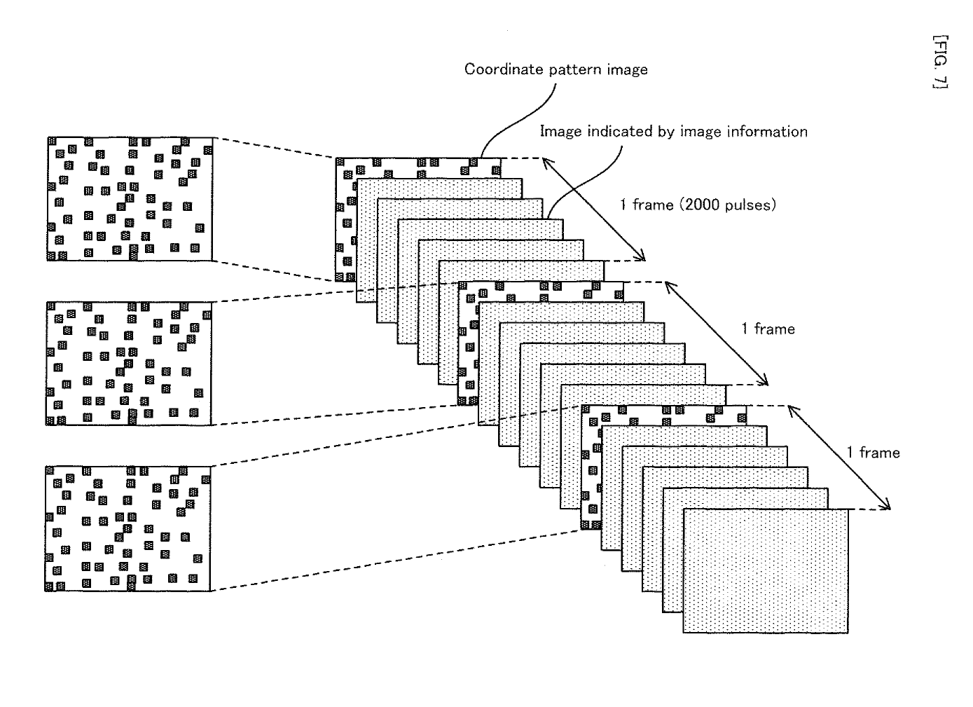

Now, with reference to FIG. 6 and FIG. 7, a more detailed explanation will be given on the operation of displaying the coordinate pattern image and the image information obtained in the step S101 in FIG. 5. FIG. 6 is a waveform chart conceptually showing the 2000 pulses which constitute one frame image. FIG. 7 is a schematic diagram conceptually showing a display aspect of the coordinate pattern image and the image information obtained in the step S101 in FIG. 5.

As shown in FIG. 6, one frame image is displayed by driving the light emitting elements or the like which constitute the pixels on the display device 114 on the basis of the 2000 pulses which have different light-emitting time lengths. In other words, one frame image is formed by time-integrating the light emission from the light emitting elements or the like driven by the 2000 pulses. Here, the first two pulses of the 2000 pulses are considered as reset pulses for canceling an influence by the previous one frame image, and this first two pulse period is defined as a reset period. In other words, in the first example, a reset operation of the display apparatus 11 is performed in a frame cycle.

At this time, a period or term from the leading edge of one pulse to the leading edge of a next pulse is defined as a sub field. Therefore, in the first example, there are a plurality of sub fields. In the first example, the first one or several of the plurality of sub fields (referred to as a sub field for displaying the coordinate information, in FIG. 6) are used to display the coordinate pattern image. In other words, the pulses in the reset period are used to display the coordinate pattern image. Moreover, the other sub fields (referred to as a sub field for displaying the image information, in FIG. 6) are used to display the image indicated by the image information.

By driving the light emitting elements or the like which constitute the display device 114 in accordance with the pulses, the image shown in FIG. 7 is displayed on the display device 114. In other words, after the coordinate pattern image is displayed at the beginning of one frame, the image indicated by the image information is displayed. Such display is repeated by a frame unit. Therefore, the pen-type indicator 12 drives the sensing device 121 in the first timing of the one frame detected by the coordinate information display synchronization sensor 123, thereby detecting the coordinate pattern image displayed at the beginning of the one frame. Incidentally, the operation of detecting the first timing of the one frame will be detailed later.

In FIG. 5 again, on the other hand, as a result of the judgment in the step S104, if it is judged that now is not the timing to display the normal image which is not the pattern image (the step S104: No), the operational flow returns to the step S102, and the operations in the step S102 and the subsequent steps are repeated.

Then, it is judged whether or not the display of the image is to be ended (step S106).

As a result of the judgment in the step S106, if it is judged that the display of the image is not to be ended (the step S106: No), the operational flow returns to the step S102, and the operations in the step S102 and the subsequent steps are repeated.

On the other hand, as a result of the judgment in the step S106, if it is judged that the display of the image is to be ended (the step S106: Yes), the operation of displaying the image on the display apparatus 11 is ended.

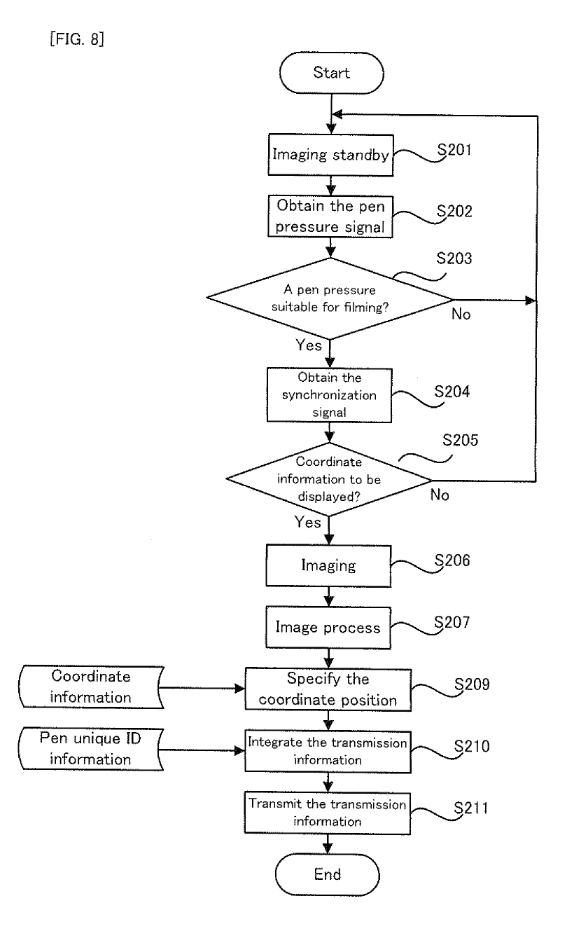

Next, with reference to FIG. 8, the operation principle of the pen-type indicator 12 will be described. FIG. 8 is a flowchart conceptually showing a flow of the operations of the pen-type indicator 12 in the first example.

As shown in FIG. 8, the operation of detecting the coordinate pattern image by the sensing device 121 (in other words, an imaging operation) goes into standby mode (step S201).

Then, the sensing device 121 obtains the pen pressure signal outputted from the pen pressure sensor 122 (step S202). Then, it is judged whether or not the distance between the pen-type indicator 12 and the display device 114 is a distance which allows the sensing device 121 to detect the image, on the basis of the obtained pen pressure signal (step S203). The details of the judgment operation are as described above.

As a result of the judgment in the step S203, if it is judged that the distance between the pen-type indicator 12 and the display device 114 is not the distance which allows the sensing device 121 to detect the image (the step S203: No), the operational flow returns to the step S201, and the operations in the step S201 and the subsequent steps are repeated.

On the other hand, as a result of the judgment in the step S203, if it is judged that the distance between the pen-type indicator 12 and the display device 114 is the distance which allows the sensing device 121 to detect the image (the step S203: Yes), then, the sensing device 121 obtains the synchronization signal outputted from the coordinate information display synchronization sensor 123 (step S204). Then, it is judged whether or not it is the timing in which the coordinate pattern image is displayed on the display device 114, on the basis of the obtained synchronization signal (step S205).

As a result of the judgment in the step S205, if it is judged that it is not the timing in which the coordinate pattern image is displayed on the display device 114 (the step S205: No), the operational flow returns to the step S201, and the operations in the step S201 and the subsequent steps are repeated.

On the other hand, as a result of the judgment in the step S205, if it is judged that it is the timing in which the coordinate pattern image is displayed on the display device 114 (the step S205: Yes), the coordinate pattern image is detected by the sensing device 121 (step S206).

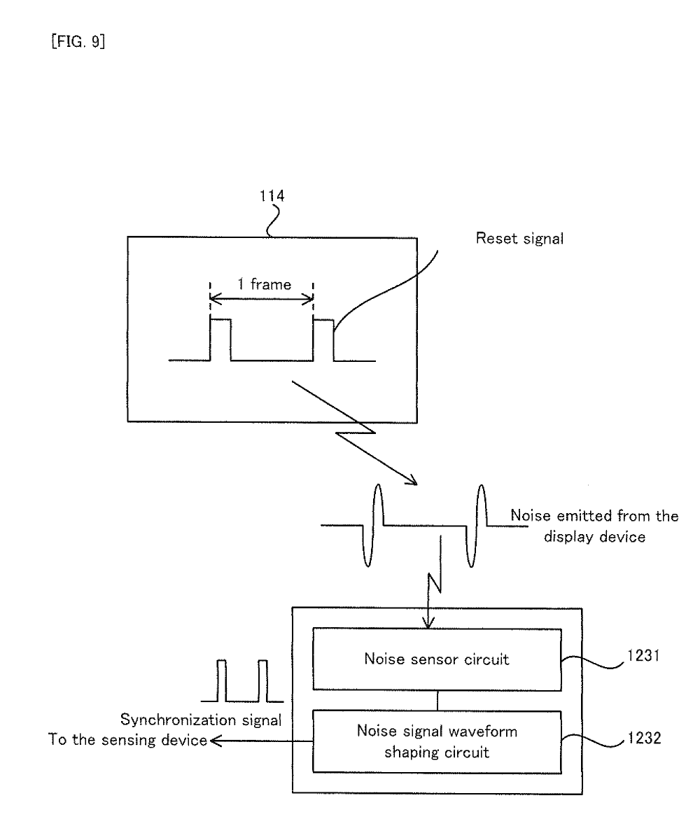

Now, with reference to FIG. 9, an explanation will be given on the operation of detecting the timing in which the coordinate pattern image is displayed on the display device 114. FIG. 9 is a waveform chart showing a principle of the operation of detecting the timing in which the coordinate pattern image is displayed on a display device and a block diagram conceptually showing the detailed structure of the coordinate information display synchronization sensor 123.

As shown in FIG. 9, in the first example, the reset operation of the display apparatus 11 is performed in the frame cycle. At this time, the reset pulse is used, and a peculiar noise is emitted from the surface of the display device 114 in accordance with the reset pulse. The coordinate information display synchronization sensor 123 detects the noise peculiar to the reset pulse, by the operation of a noise sensor circuit 1231 disposed therein. After that, the coordinate information display synchronization sensor 123 generates the synchronization signal by shaping the waveform of the detected noise by the operation of a noise signal waveform shaping circuit 1232 provided therein. The synchronization signal is, for example, a signal whose signal level becomes high in the timing in which the noise is detected (i.e. a signal which rises in substantially the same timing as the reset pulse).

Therefore, the timing in which the signal level of the synchronization signal becomes high is the timing in which the coordinate pattern image is displayed on the display device 114. On the sensing device 121, the coordinate pattern image is detected in the timing in which the signal level of the synchronization signal becomes high.

Incidentally, in general, if a next frame image is displayed after one frame image is displayed, not only the reset process but also a predetermined process are performed, and as a result, a noise peculiar to the predetermined process is emitted. Therefore, even if it is constructed to detect not only the noise peculiar to the reset operation but also the noise peculiar to the predetermined process performed when a next frame image is displayed after one frame image is displayed, it is possible to detect the coordinate pattern image.

In FIG. 8 again, the coordinate pattern image detected on the sensing device 121 is converted into a format easily processed at the subsequent stage of the image processing device 124, by the operation of the image processing device 124 (step S207).

Then, by the operation of the position detection device 125, the coordinate position indicated by the coordinate pattern image is detected with reference to display unique coordinate information stored in the information memory device 126 (step S209).

Then, the information indicating the coordinate position specified on the position detection device 125 and the pen unique ID information about each pen-type apparatus 12 stored in the pen unique ID information memory device 129 are integrated by the operation of the transmission information integration device 127, by which the transmission information is generated (step S210).

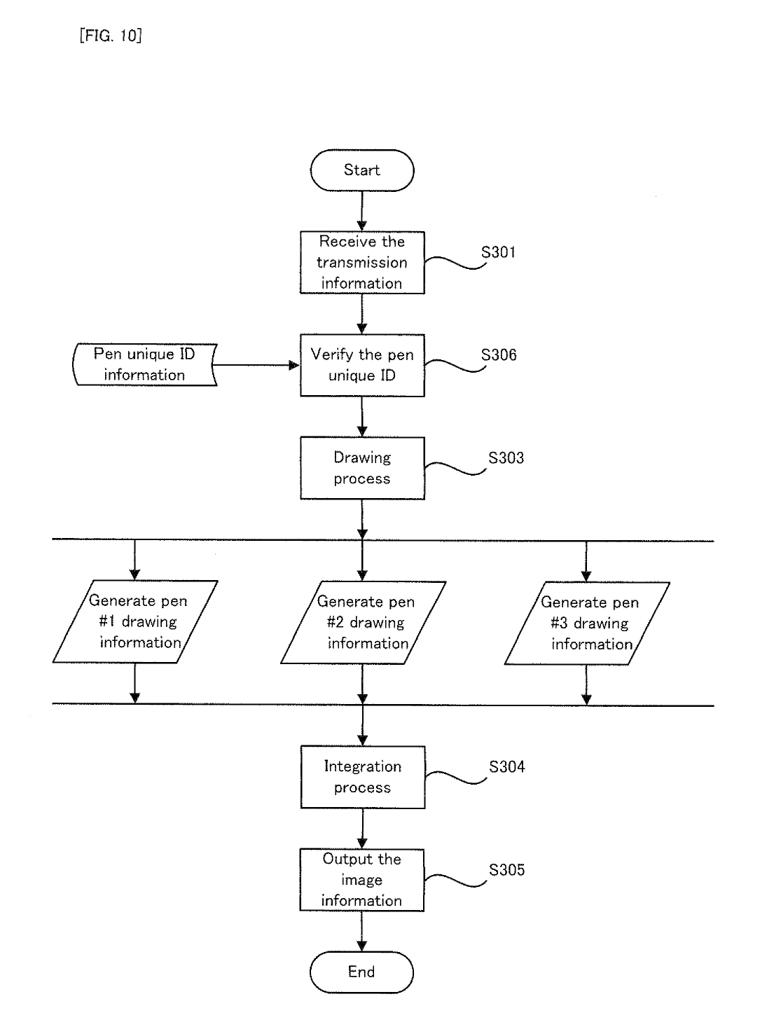

Next, with reference to FIG. 10, the operation principle of the application apparatus 13 will be described. FIG. 10 is a flowchart conceptually showing a flow of the operations of the application apparatus 13 in the first example.

As shown in FIG. 10, firstly, the transmission information is received by the operation of the wireless reception device 131 (step S301).

Then, by analyzing the transmission information with reference to the pen unique ID information stored in the pen unique ID information memory device 136 by the operation of the input processing device 132, it is confirmed which pen-type indicator 12 the transmission information corresponds to (i.e. the pen-type indicator 12 that draws the trajectory indicated by the coordinate position included in the transmission information is confirmed) (step S306).

Then, the drawing information for performing the drawing process at the coordinate position is generated for each pen-type indicator 12, on the basis of the coordinate position included in the transmission information, by the operation of the drawing processing device 133 (step S303). As a result, the drawing information indicating the trajectory of the pen-type indicator (#1) 12 (#1), the drawing information indicating the trajectory of the pen-type indicator (#2) 12 (#2), and the drawing information indicating the trajectory of the pen-type indicator (#3) 12 (#3) are generated.

Incidentally, if the operation by a certain pen-type indicator 12 is not performed, obviously, it is unnecessary to generate the drawing information indicating the trajectory of the pen-type indicator 12.

Then, the pieces of drawing information generated for respective pen-type indicators 12 are integrated as one drawing information by the operation of the integration processing device 134 (step S304), and the integrated drawing information is converted to the image information and outputted to the display apparatus 11 by the operation of the image information output device 135.

As a result, on the display device 114 of the display apparatus 11, the desired image is displayed, and the drawing is performed in accordance with the trajectory of the displacement of the pen-type indicator 12, as shown in FIG. 1.

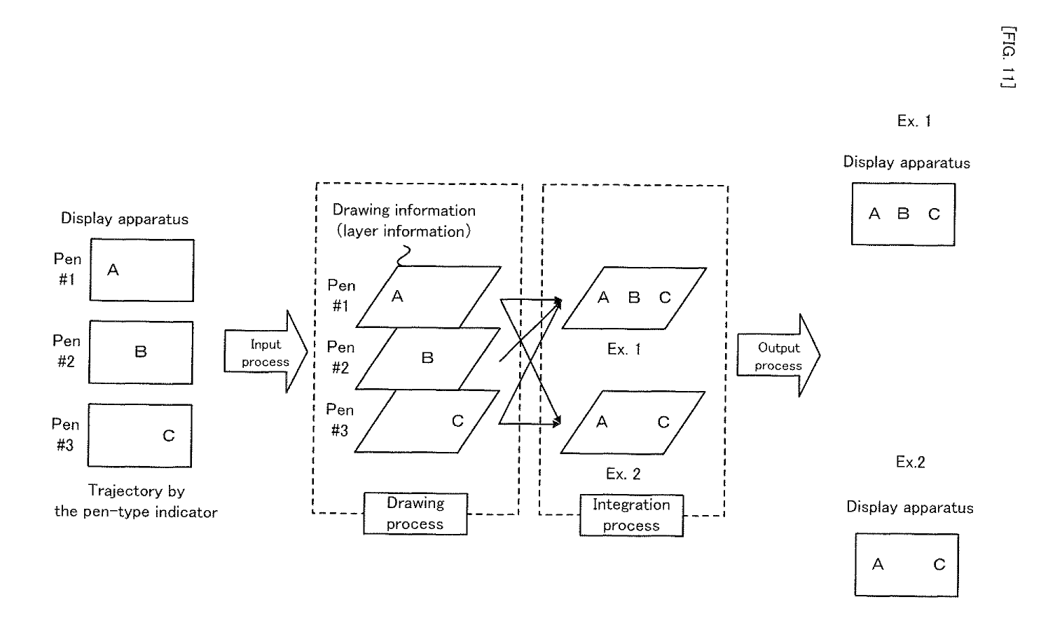

Now, with reference to FIG. 11, an explanation will be given on the drawing process, the integration process, and the image displayed as a result. FIG. 11 is a schematic diagram conceptually showing the drawing process, the integration process, and the image displayed as a result.

As shown on the left side in FIG. 11, it is assumed that the pen-type indicator (#1) 12 (#1) is operated by a user to draw a letter of “A” on the left side of the display device 114 of the display apparatus 11, that the pen-type indicator (#2) 12 (#2) is operated by the user to draw a letter of “B” in the center of the display device 114 of the display apparatus 11, and that the pen-type indicator (#3) 12 (#3) is operated by the user to draw a letter of “C” on the right side of the display device 114 of the display apparatus 11.

At this time, as shown in the center in FIG. 11, the drawing processing device 133 generates the drawing information for performing the drawing process at the coordinate position, as the layer information for each pen-type indicator 12. Specifically, for example, the drawing processing device 133 generates the drawing information as the layer information according to the trajectory that the pen-type indicator (#1) 12 (#1) draws a letter of “A”, the layer information according to the trajectory that the pen-type indicator (#2) 12 (#2) draws a letter of “B”, and the layer information according to the trajectory that the pen-type indicator (#3) 12 (#3) draws a letter of “C”.

The integration processing device 134 integrates the drawing information (or layer information) generated by the drawing processing device 133 in accordance with a predetermined criterion. For example, in an <example 1>, the pieces of layer information in all the terms between a term t1 to a term t6 are integrated to one drawing information. On the other hand, in an <example 2>, the pieces of layer information in the term t1, the term t5, and the term t6 are integrated to one drawing information. Of course, the layer information may be integrated in another aspect. The integration processing device 134 integrates the drawing information (or layer information) generated by a drawing processing device 133a in accordance with a predetermined reference. For example, in the <example 1>, all the pieces of layer information corresponding to a pen-type indicator (#1) 12a (#1) to a pen-type indicator (#6) 12a (#6) are integrated to one drawing information. On the other hand, in the <example 2>, the pieces of layer information corresponding to the pen-type indicator (#1) 12a (#1), the pen-type indicator (#3) 12a (#3), and the pen-type indicator (#6) 12a (#6) are integrated to one drawing information. Of course, the layer information may be integrated in another aspect.

As a result, if the drawing information integrated as shown in the <example 1> is converted to the image information and outputted to the display apparatus 11, “ABC” is displayed on the display apparatus 11 as shown on the upper right side in FIG. 11. On the other hand, if the drawing information integrated as shown in the <example 2> is converted to the image information and outputted to the display apparatus 11, “AC” is displayed on the display apparatus 11 as shown on the lower right side in FIG. 11.

As explained above, according to the input system 1 in the first example, a user can draw the desired letter or character, graphic, and the like on the display apparatus 11 by using the pen-type indicator 12, feeling extremely similar to the conventionally used whiteboard.

In particular, one portion of the image displayed on the display device 114 includes the coordinate pattern image, and the coordinate position of each of the plurality of pen-type indicators 12 on the display device 114 (i.e. each of the trajectories formed by the plurality of pen-type indicators 12 being displaced on the display device 114) is specified on the basis of the coordinate pattern image detected by each of the plurality of pen-type indicators 12. In other words, by using the normal image display operation principle of the display apparatus 11, the coordinate position of each of the plurality of pen-type indicators 12 is specified. Thus, even if the display device 114 of the display apparatus increases in size (e.g. the number of inches increases), power consumption and manufacturing costs necessary to specify the coordinate position of each of the plurality of pen-type indicators 12 rarely increase.

Moreover, after the pen unique ID information is assigned to each pen-type indicator 12 and it is integrated to the transmission information, the integrated information is transmitted is transmitted to the application apparatus 13. Therefore, even if the plurality of pen-type indicators 12 are associated with one display apparatus 11, it is possible to preferably specify the trajectory drawn by each pen-type indicator 12.

Moreover, even if a plurality of display apparatuses 11 are adjacently disposed, it is possible to specify the coordinate position on the display device 114 of each of the plurality of pen-type indicators 12 without interference from the adjacent display apparatus 11. Specifically, for example, as long as the pen-type indicator (#1) 12 (#1) is displaced on the display device 114 of a display apparatus (#1) 11 (#1), the displacement of the pen-type indicator (#1) 12 (#1) does not have an adverse effect on another display apparatus (#2) 11 (#2), and moreover, the presence of this another display apparatus (#2) 11 (#2) does not have an adverse effect on the specification of the coordinate position of the pen-type indicator (#1) 12 (#1). By this, even if the plurality of display apparatuses 11 are arranged, a user can draw the desired letter or character, graphic, and the like on the desired display apparatus 11 of the plurality of display apparatuses 11, by using the plurality of pen-type indicators 12 without a particular inconvenience.

In addition, the drawing information is generated as the layer information. Thus, it is possible to selectively perform the drawing process corresponding to the trajectory drawn in the desired timing of the trajectories of the displacement by the plurality of pen-type indicators 12. In the same manner, it is possible to selectively perform the drawing process corresponding to the trajectory drawn by the desired pen-type indicator 12 of the trajectories of the displacement by the plurality of pen-type indicators 12.

Moreover, since the coordinate pattern image is displayed by using one or several of the 2000 pulses for displaying one frame image, the coordinate pattern image is rarely visually recognized by a user. Moreover, since the display of the coordinate pattern image has little effect on the display of the image to be originally displayed, the deterioration of the image quality of the image to be originally displayed is rarely visually recognized by the user. Therefore, no matter what image is displayed on the display apparatus 11, the aforementioned structure can be adopted. In other words, it is possible to realize the input system 1 of high versatility.

Incidentally, the aforementioned example exemplifies the use of the 2000 pulse for displaying one frame image; however, obviously, the number of pulses for displaying one frame image is not limited to this.

Moreover, various processes on the application apparatus 13 (specifically, the input process, the drawing process, the integration process, and the like) may be performed in dedicated hardware. Alternatively, they may be performed in software which operates on a CPU. If they may be performed in software, it is possible to receive such an effect that the structure of the application apparatus 13 can be simplified.

### (2) Second Example

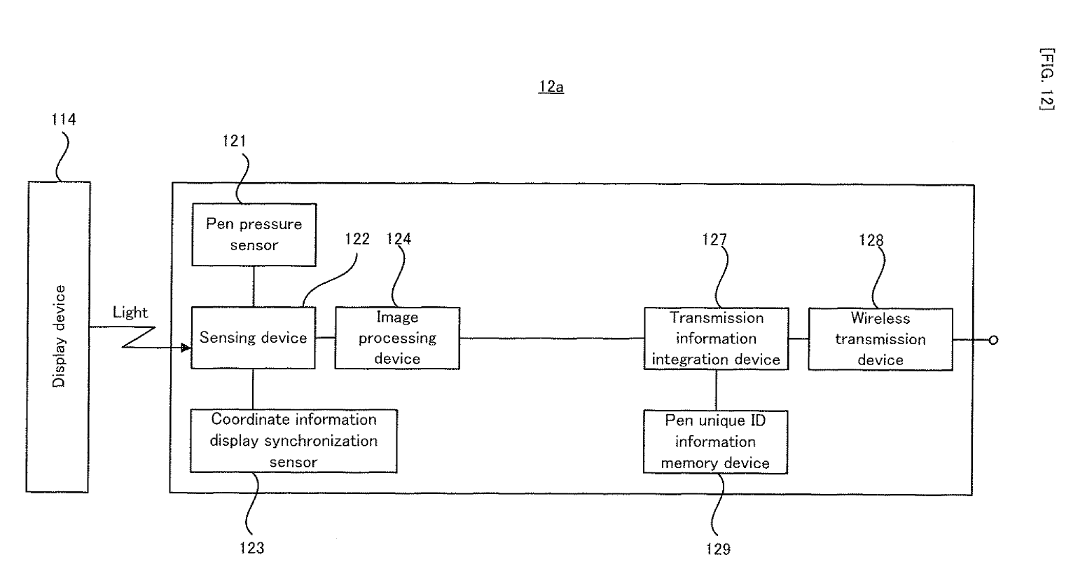

Next, with reference to FIG. 12 to FIG. 15, a second example of the input system of the present invention will be explained. Incidentally, the same constituent or operation as that of the input system 1 in the first example described above will carry the same referential numeral or step number, and the detailed explanation thereof will be omitted.

(2-1) Basic Structure

An input system 1a in the second example is provided, as the basic structure, with the display apparatus 11, a plurality of pen-type indicators 12a (specifically, a pen-type indicator (#1) 12a (#1), a pen-type indicator (#2) 12a (#2), and a pen-type indicator (#3) 12a (#3)), and an application apparatus 13a, as in the input system 1 in the first example.

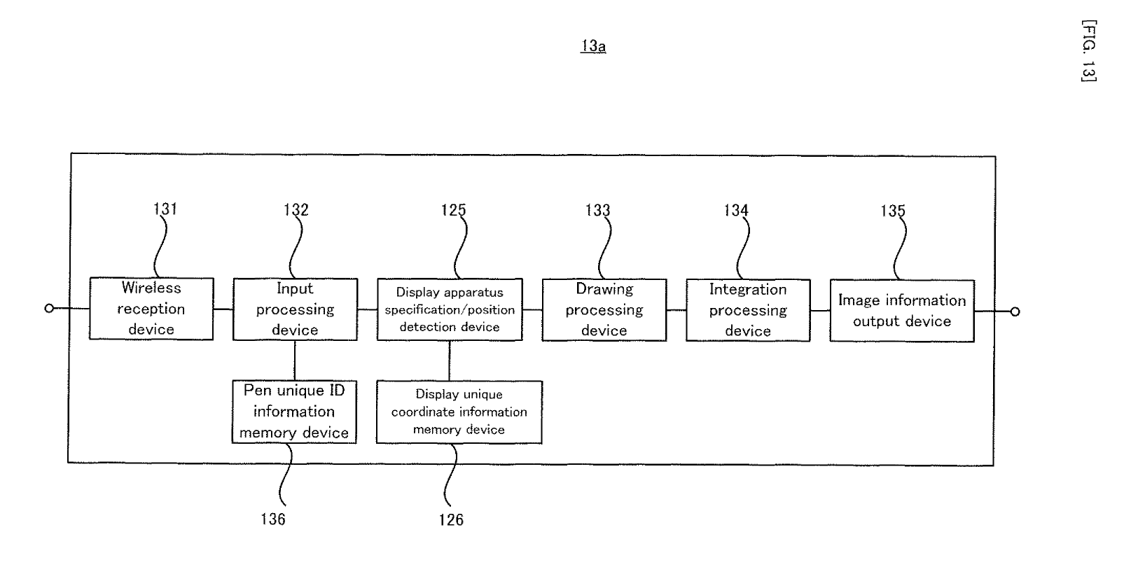

In the second example, the inner structures of the pen-type indicator 12a and the application apparatus 13a are different from those of the pen-type indicator 12 and the application apparatus 13 in the first example. Hereinafter, with reference to FIG. 12 and FIG. 13, an explanation will be given on the basic structures of the pen-type indicator 12a and the application apparatus 12a in the second example. FIG. 12 is a block diagram conceptually showing the basic structure of the pen-type indicator 12a in the second example. FIG. 13 is a block diagram conceptually showing the basic structure of the application apparatus 13a in the second example.

As shown in FIG. 12, the pen-type indicator 12a is provided with the sensing device 121, the pen pressure sensor 122, the coordinate information display synchronization sensor 123, the image processing device 124, the transmission information integration device 127, the wireless transmission device 128, and the pen unique ID information memory device 129. In other words, the pen-type indicator 12a in the second example has the structure that the position detection device 125 and the coordinate information memory device 126 are eliminated, as compared to the pen-type indicator 12 in the first example described above.

Therefore, the pen-type indicator 12a in the second example allows the coordinate pattern outputted from the image processing device 124 to be the transmission information without change, and it does not perform the operation of detecting the coordinate position indicated by the coordinate pattern image. Therefore, the transmission information integration device 127 in the second example integrates the coordinate pattern image outputted from the image processing device 124 and the pen unique ID stored in the pen unique ID information memory device 129, thereby generating the transmission information.

As shown in FIG. 13, the application apparatus 13a is provided with the wireless reception device 131, the input processing device 132, the drawing processing device 133, the integration processing device 134, the image information output device 135, the position detection device 125, and the coordinate position memory device 126. In other words, the application apparatus 13a in the second example has the structure that the position detection device 125 and the coordinate position memory device 126 are added, as compared to the application apparatus 13 in the first example described above.

Therefore, the application apparatus 13a in the second example performs the operation of detecting the coordinate position indicated by the coordinate pattern image, which is performed by the pen-type indicator 12 in the first example, on the basis of the transmission information outputted from the input processing device 132.

(2.2) Operation Principle

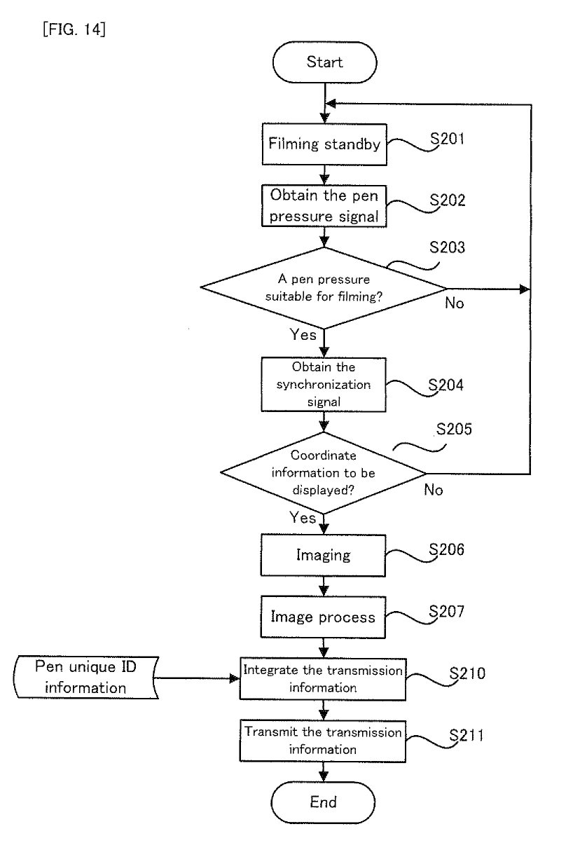

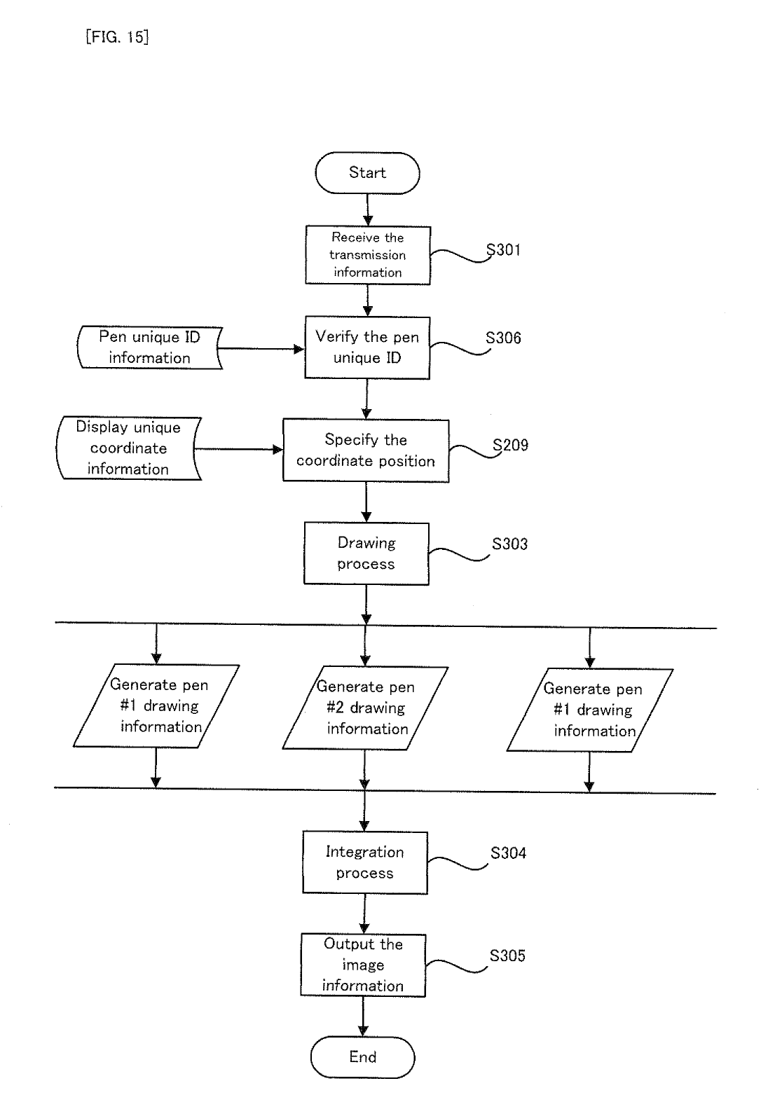

Next, with reference to FIG. 14 and FIG. 15, an explanation will be given on the operation principle of the input system 1a in the second example.

Firstly, with reference to FIG. 14, the operation principle of the pen-type indicator 12a will be described. FIG. 14 is a flowchart conceptually showing a flow of the operations of the pen-type indicator 12a in the second example.

As shown in FIG. 14, the operations from the step S201 to the step S207 are performed in the same manner as the operations of the pen-type indicator 12 in the first example described above.

Then, the coordinate pattern image outputted from the image processing device 124 and the pen unique ID stored on the pen unique ID information memory device 129 are integrated, by which the transmission information is generated (step S210).

Then, in the same manner as the operation of the pen-type indicator 12 in the first example, the generated transmission information is transmitted to the application apparatus (step S211).

Next, with reference to FIG. 15, the operation principle of the application apparatus 13a will be described. FIG. 15 is a flowchart conceptually showing a flow of the operations of the application apparatus 13a in the second example.

As shown in FIG. 15, the operations from the step S301 to the step S306 are performed in the same manner as the operations of the pen-type indicator 12 in the first example described above.

Then, by the operation of the position detection device 125, the coordinate position indicated by the coordinate pattern image is detected with reference to the coordinate information stored in the coordinate information memory device 126 (step S209).

The subsequent operations from the step S303 to the step S305 are performed in the same manner as the operations of the pen-type indicator 12 in the first example described above.

As explained above, according to the input system 1a in the second example, it is possible to receive the same effect as that received by the input system 1 in the first example described above.

In the input system 1a in the second example, in particular, the position detection device 125 and the coordinate information memory device 126 are provided for the single application apparatus 13a commonly used for the display apparatus 11 and the plurality of pen-type indicators 12a. Therefore, it is possible to simplify the structure of each of the plurality of pen-type indicators 12a. As a result, it is possible to reduce the manufacturing costs and the power consumption of the plurality of pen-type indicators 12a. Considering that the input system 1a is provided with the plurality of pen-type indicators 12a, the reduction in the manufacturing costs and the power consumption of the plurality of pen-type indicators 12a also lead to the reduction in the manufacturing costs and the power consumption of the entire input system 1a as a whole.

The present invention is not limited to the aforementioned examples, but various changes may be made, if desired, without departing from the essence or spirit of the invention which can be read from the claims and the entire specification. An input system and method, and a computer program, all of which involve such changes, are also intended to be within the technical scope of the present invention.

1. An input system comprising:
a display apparatus for displaying an image on a display surface, the image including coordinate information indicating a coordinate position on the display surface;
a plurality of indicating apparatuses for giving an indication for a drawing process with respect to said display apparatus by being displaced on the display surface, each of said indicating apparatuses comprising (i) a detecting device for detecting the image displayed on the display surface and (ii) a transmitting device for transmitting transmission information generated on the basis of the coordinate information included in the image detected by said detecting device; and
a control apparatus for controlling the drawing process with respect to said display apparatus on the basis of the indication by each of said plurality of indicating apparatuses, said control apparatus comprising (i) a receiving device for receiving the transmission information transmitted by said transmitting device, (ii) a generating device for generating drawing information on the basis of the transmission information, the drawing information indicating a trajectory that each of said plurality of indicating apparatuses is displaced on the display surface, and (iii) a controlling device for controlling said display apparatus to perform the drawing process according to the drawing information generated by said generating device,
said display apparatus displaying one image by emitting a plurality of pulses, said display apparatus also displaying the coordinate information on the display surface by using one portion of the plurality of pulses emitted in predetermined timing,
said detecting device detecting the image in the predetermined timing in which the coordinate information is displayed on the display surface,
said display apparatus displaying one image by emitting a plurality of pulses, said display apparatus displaying the coordinate information on the display surface by using the one portion of the plurality of pulses emitted in initial timing.

2. (canceled)

3. The input system according to claim 1, wherein
each of said plurality of indicating apparatuses further comprises a synchronizing device for detecting the predetermined timing in which the coordinate information is displayed on the display surface, and
said detecting device detects the image in the predetermined timing detected by said synchronizing device.

4. The input system according to claim 3, wherein
said display apparatus displays one image by emitting a plurality of pulses and displays the coordinate information on the display surface by using one portion of the plurality of pulses emitted in initial timing, and
said synchronizing device detects the timing in which the coordinate information is displayed on the display surface by detecting a noise pulse emitted from the display surface between completion of the display of the one image and beginning of the display of an image to be displayed next to the one image.

5. The input system according to claim 1, wherein
one of said plurality of indicating apparatuses further comprising a specifying device for specifying the coordinate position at which the one indicating apparatus is located on the display surface, on the basis of the coordinate information included in the image detected by said detecting device, and
said transmitting device transmits the coordinate position specified by said specifying device as the transmission information.

6. The input system according to claim 1, wherein said generating device further comprises a specifying device for specifying the coordinate position at which each of said plurality of indicating apparatuses is located on the display surface, on the basis of the transmission information transmitted by said transmitting device.

7. The input system according to claim 1, wherein
said generating device generates the drawing information indicating the trajectory that each of said plurality of indicating apparatuses is displaced on the display surface, as a plurality of layer information distinguished in accordance with time, and
said controlling device controls said display apparatus to perform the drawing process according to any one of, or an integrated result of at least two or all of the plurality of layer information.

8. The input system according to claim 1, wherein said generating device generates the drawing information indicating the trajectory that each of said plurality of indicating apparatuses is displaced on the display surface, for each of said plurality of indicating apparatuses.

9. The input system according to claim 8, wherein
unique identification information for an indicating apparatus is assigned to each of said plurality of indicating apparatuses, and
said transmitting device transmits the transmission information including each of the coordinate information and the identification information for an indicating apparatus.

10. The input system according to claim 5, wherein
said generating device generates the drawing information indicating the trajectory that each of said plurality of indicating apparatus is displaced on the display surface, as a plurality of layer information distinguished in accordance with each of said plurality of indicating apparatuses, and
said controlling device controls said display apparatus to perform the drawing process according to any one of, or an integrated result of at least two or all of the plurality of layer information.

11. An input method in an input system comprising: a display apparatus for displaying an image on a display surface, the image including coordinate information indicating a coordinate position on the display surface; a plurality of indicating apparatuses for giving an indication for a drawing process with respect to said display apparatus by being displaced on the display surface; and a control apparatus for controlling the drawing process with respect to said display apparatus on the basis of the indication by each of said plurality of indicating apparatuses, said input method comprising:
(i) a detecting process of detecting the image displayed on the display surface and (ii) a transmitting process of transmitting transmission information generated on the basis of the coordinate information included in the image detected by said detecting process, which are performed on each of said plurality of indicating apparatuses; and
(i) a receiving process of receiving the transmission information transmitted by said transmitting process, (ii) a generating process of generating drawing information on the basis of the transmission information, the drawing information indicating a trajectory that each of said plurality of indicating apparatuses is displaced on the display surface, and (iii) a controlling process of controlling said display apparatus to perform the drawing process according to the drawing information generated by said generating process, which are performed on said control apparatus,
said display apparatus displaying one image by emitting a plurality of pulses, said display apparatus also displaying the coordinate information on the display surface by using one portion of the plurality of pulses emitted in predetermined timing,
said detecting process detecting the image in the predetermined timing in which the coordinate information is displayed on the display surface,
said display apparatus displaying one image by emitting a plurality of pulses, said display apparatus displaying the coordinate information on the display surface by using the one portion of the plurality of pulses emitted in initial timing.

12. A computer-readable medium containing a computer program for controlling a computer provided for an input system comprising:
a display apparatus for displaying an image on a display surface, the image including coordinate information indicating a coordinate position on the display surface;
a plurality of indicating apparatuses for giving an indication for a drawing process with respect to said display apparatus by being displaced on the display surface, each of said indicating apparatuses comprising (i) a detecting device for detecting the image displayed on the display surface and (ii) a transmitting device for transmitting transmission information generated on the basis of the coordinate information included in the image detected by said detecting device; and
a control apparatus for controlling the drawing process with respect to said display apparatus on the basis of the indication by each of said plurality of indicating apparatuses, said control apparatus comprising (i) a receiving device for receiving the transmission information transmitted by said transmitting device, (ii) a generating device for generating drawing information on the basis of the transmission information, the drawing information indicating a trajectory that each of said plurality of indicating apparatuses is displaced on the display surface, and (iii) a controlling device for controlling said display apparatus to perform the drawing process according to the drawing information generated by said generating device,
said display apparatus displaying one image by emitting a plurality of pulses, said display apparatus also displaying the coordinate information on the display surface by using one portion of the plurality of pulses emitted in predetermined timing,
said detecting device detecting the image in the predetermined timing in which the coordinate information is displayed on the display surface,
said display apparatus displaying one image by emitting a plurality of pulses, said display apparatus displaying the coordinate information on the display surface by using the one portion of the plurality of pulses emitted in initial timing,
said computer program making the computer function as at least one portion of said plurality of indicating apparatuses and said control apparatus.
